(19) United States
(12) Patent Application Publication
(10) Pub. No.: US 2009/0072674 A1
(43) Pub. Date: Mar. 19, 2009

(54) Stepping Motor

(75) Inventors: Takayuki Yamawaki, Shizuoka (JP); Taketoshi Ohyashiki, Shizuoka (JP)

Correspondence Address: FOLEY AND LARDNER LLP;SUITE 500, 3000 K STREET NW, WASHINGTON, DC, 20007, US

(73) Assignee: Minebea Motor Manufacturing Corporation

(21) Appl. No.: 11/887,908

(22) PCT Filed: Apr. 6, 2006
(86) PCT No.: PCT/JP2006/307345

§ 371 Date: Oct. 4, 2007

(30) Foreign Application Priority Data
Apr. 6, 2005 (JP) 2005-110409

(51) Int. Cl. H02K 37/12

(52) U.S. Cl. 310/49 R

(57) ABSTRACT

A stepping motor has stators arranged at both end sides in the direction of a shaft of a rotor magnet, each of the stators includes inner and outer yokes having pole teeth opposed to the outer peripheral surface of the rotor magnet, at least the outer yoke among the inner and outer yokes has a tubular bending part, and the bending part is fixed to a cylindrical core made of a magnetic material.

### TECHNICAL FIELD

The present invention relates to a stepping motor used for an actuator of an optical disk device or a video camera, and more particularly to a stepping motor having stators that are arranged at both end sides in the direction of a shaft of a rotor and include inner and outer yokes each having pole teeth, in which the inner and outer yokes are stably provided in a cylindrical core with wide contact areas.

### BACKGROUND ART

Usually, with a request for the miniaturization of various kinds of electronic devices, a motor accommodated in the device is also requested to be miniaturized to meet a space for accommodating the motor. For this request, a stepping motor having a compact form and a small diameter, which includes stators arranged at both ends in the axial direction of a rotor magnet, has been proposed (for instance, see Patent Document 1). In FIGS. 6 and 7, the structure of the stepping motor is shown. FIG. 6 is an exploded perspective view and FIG. 7 is a sectional view.

In these drawings, a rotor 110 of a stepping motor 100 has a rotor magnet 111 with a multipolar magnetization applied to its outer periphery and a shaft 112 and is rotatably supported by bearings 133 at both ends of the rotor. Stators 120a and 120b are formed with assemblies of the same forms and opposed at both end sides in the axial direction of the rotor magnet 111. The stators 120a and 120b include respective inner yokes 121, bobbins 122 and outer yokes 123 of the same forms, and are assembled by axially fitting these members.

Further, the stators 120a and 120b include cylindrical bosses 124 made of a magnetic material and provided in the inside diameter side (means the inside diameter side to an outside diameter side) of the bobbins 122 to magnetically and mechanically connect the inside diameter of the inner yokes 121 and the inside diameter of the outer yokes 123.

The inner yoke 121 and the outer yoke 123 are made of a magnetic material and each includes pole teeth 121b and 123b extending from flat plate parts 121a and 123a toward the shaft (the shaft 112) and opposed to the outer peripheral surface of the rotor magnet 111.

The pole teeth 121b of the inner yoke 121 and the pole teeth 123b of the outer yoke 123 are arranged at positions having a phase difference of 180° in an electrical angle. Further, both the stators 120a and 120b are arranged at positions having a phase difference of 90° in an electrical angle.

113 designates a washer made of a resin, 125 designates a coil wound on the bobbin 122, 126 designates a terminal pin planted on the bobbin 122, 131 designates a case made of a non-magnetic material for holding the stators 120 and 134 is a spacer made of a non-magnetic material and attached between the stators 120a and 120b.

The inner yoke 121 and the outer yoke 123 are ordinarily manufactured by a press working, and the pole teeth 121b and the pole teeth 123b as well as an opening part 121c of the flat plate part 121a of the inner yoke 121 and an opening part 123c of the flat plate part 123a of the outer yoke 123 are formed by a bending work. The cylindrical boss 124 is fitted to the opening part 121c of the inner yoke 121 and the opening part 123c of the outer yoke 123 to magnetically and mechanically connect the inner yoke 121 to the outer yoke 123.

Since the above-described stepping motor has such a structure that the inner yoke 121 and the outer yoke 123 come into contact with the boss 124 in the peripheral surface of the opening part 121c of the inner yoke 121 and the peripheral surface of the opening part 123c of the outer yoke 123, a large contact area cannot be obtained. In other words, the thickness of the flat plate part 121a and the flat plate part 123a forms the contact area.

Further, since the opening part 121c of the inner yoke 121 and the opening part 123c of the outer yoke 123 are formed by the press working, the end faces of the opening part 121c and the opening part 123c each are cut so as to be dragged during the press working. Therefore, cutting planes are liable to be deformed. As a result, the fitting state of the inner yoke 121, the outer yoke 123 and the boss 124 is such a state as shown in a schematic view of FIG. 8. In FIG. 8, the contact area of the inner yoke 121 and the boss 124 and the contact area of the outer yoke 123 and the boss 124 are smaller than the thickness of the flat plate parts 121a and 123a due to a deformation during the press working, and thus a magnetic resistance is increased to increase a leakage flux. Further, when the magnetic resistance is increased, a magnetic saturation is apt to occur at the contact parts. Consequently, the torque of a motor is lowered.

Further, when the inner yoke 121 is fixed to the boss 124, the inner yoke is fixed to the boss by the thickness (the thickness of a plate) of the flat plate part 121a of the inner yoke 121. However, since the thickness is relatively small, the inner yoke 121 may be possibly unstably supported. Further, the same thing may be also applied to the outer yoke 123.

### Patent Document 1: JP-A-2003-9497

### DISCLOSURE OF THE INVENTION

### Problem that the Invention is to Solve

With the above-described issues taken into consideration, it is an object of the present invention to provide a stable and compact stepping motor having a small diameter, in which a contact area of an inner yoke, an outer yoke and a boss is increased, a magnetic resistance is reduced and the torque of a motor is not deteriorated.

### Means for Solving the Problem

To achieve the above-described object, the following means for solving problems are used.

(1) A stepping motor characterized in that stators are arranged at both end sides of a rotor magnet in a direction of a shaft (an axial direction of a rotor), each of the stators includes inner and outer yokes each having a plurality of pole teeth opposed to an outer peripheral surface of the rotor magnet, at least the outer yoke among the inner and outer yokes has a tubular bending part, and the bending part is fixed to the outer peripheral surface of a cylindrical core made of a magnetic material.
(2) The stepping motor according to the above described (1), characterized in that each of the inner and outer yokes has a tubular bending part fixed to the outer peripheral surface of the cylindrical core.
(3) The stepping motor according to the above-described (2), characterized in that the cylindrical core is fitted to the tubular bending part.
(4) The stepping motor according to the above-described (2), characterized in that the inner yoke includes a flat plate part and the plurality of pole teeth that are continuously provided in an outer peripheral part of the flat plate part and extend in the axial direction, the flat plate part has an opening part at its central part, and the tubular bending part is provided in the opening part, and the outer yoke includes a flat plate part and the plurality of pole teeth that are continuously provided in an outer peripheral part of the flat plate part and extend in the axial direction, the flat plate part has an opening part at its central part, and the tubular bending part is provided in the opening part.
(5) The stepping motor according to the above-described (4), characterized in that the tubular bending part of the inner yoke is provided in the same side (direction) as that of the pole teeth of the inner yoke and the tubular bending part of the outer yoke is provided in an opposite side to that of the pole teeth of the outer yoke.
(6) The stepping motor according to any one of the above-described (2) to (5), characterized in that the rotor has a recessed part at a portion opposed to the bending part of the inner yoke in the stators at both sides in the direction of the shaft.

### ADVANTAGE OF THE INVENTION

In the present invention, since the tubular bending part is formed in at least the outer yoke and the outer yoke comes into contact with the outer peripheral surface of the cylindrical core in the inner peripheral surface of the bending part, the contact area of the outer yoke and the core can be increased and a magnetic resistance at the contact part of the outer yoke and the core can be reduced, and thus, a leakage flux can be decreased. As a result, a compact stepping motor having a small diameter can be provided in which a motor torque is not deteriorated.

Further, in the present invention, since the tubular bending part is formed in each of the inner and outer yokes and the inner peripheral surface of the bending part comes into contact with the outer peripheral surface of the cylindrical core, each of the contact area of the inner yoke and the core and the contact area of the outer yoke and the core can be increased, and thus, a magnetic resistance at the contact part of the inner yoke and the core and at the contact part of the outer yoke and the core can be reduced, so that a leakage flux can be more decreased. As a result, a compact stepping motor having a small diameter can be provided in which a motor torque is not more deteriorated.

Further, since the rotor has the recessed part provided at the part opposed to the bending part of the inner yoke in the stators at both sides in the direction of the shaft, the rotor can be arranged in a narrow space without reducing a magnetic force.

### BRIEF DESCRIPTION OF THE DRAWINGS

FIG. 1 is a partly sectional perspective view showing a structure of a stepping motor of an embodiment of the present invention.

FIG. 2 is an exploded perspective view in a stator shown in FIG. 1

FIG. 3 is a perspective view showing a completed state of the stator by a resin mold.

FIG. 4 is a schematic view showing a fitting state of an inner yoke, an outer yoke and a core in FIG. 1.

FIG. 5 is a schematic view showing a fitting state of an inner yoke, an outer yoke and a core in another embodiment.

FIG. 6 is an exploded perspective view showing the structure of a stepping motor in the background art.

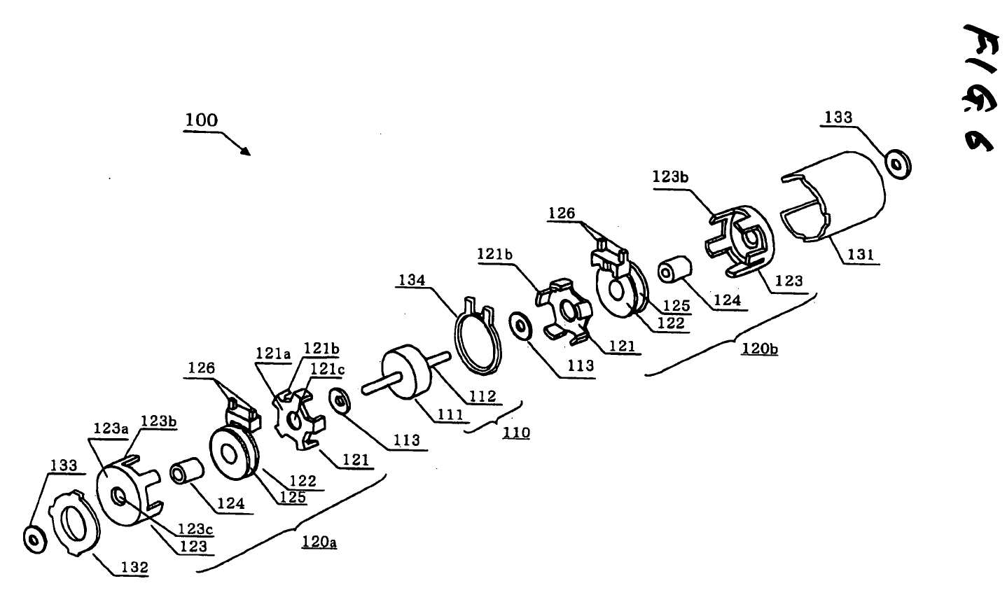

FIG. 7 is a sectional view of the stepping motor shown in FIG. 6.

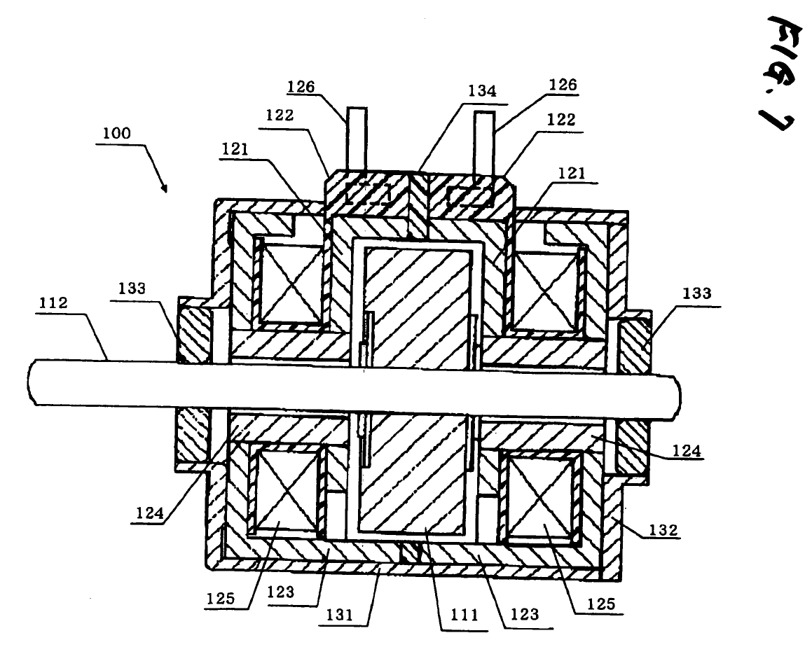

FIG. 8 is a schematic view showing a fitting state of an inner yoke, an outer yoke and a boss in FIG. 6.

### DESCRIPTION OF REFERENCE NUMERALS AND SIGNS

1 stepping motor
10, 10a, 10b stator
11 bearing
12 outer yoke
12a pole teeth
12b flat plate part
12c bending part
12e opening part
13 covering
14 bobbin
14a flange
14b flange
14c terminal base
14d terminal pin
14e coil
14f boss part
15 core
16 inner yoke
16a pole teeth
16b flat plate part
16c bending part
16d hole
16e opening part
17 resin
17a hole
17b,17b1 protruding part
30 rotor
31 rotor magnet
32 washer
33 shaft
35 pipe
36 attaching plate
37 end plate

### BEST MODE FOR CARRYING OUT THE INVENTION

Now, an embodiment of the present invention will be described below by referring to the drawings.

### First Embodiment

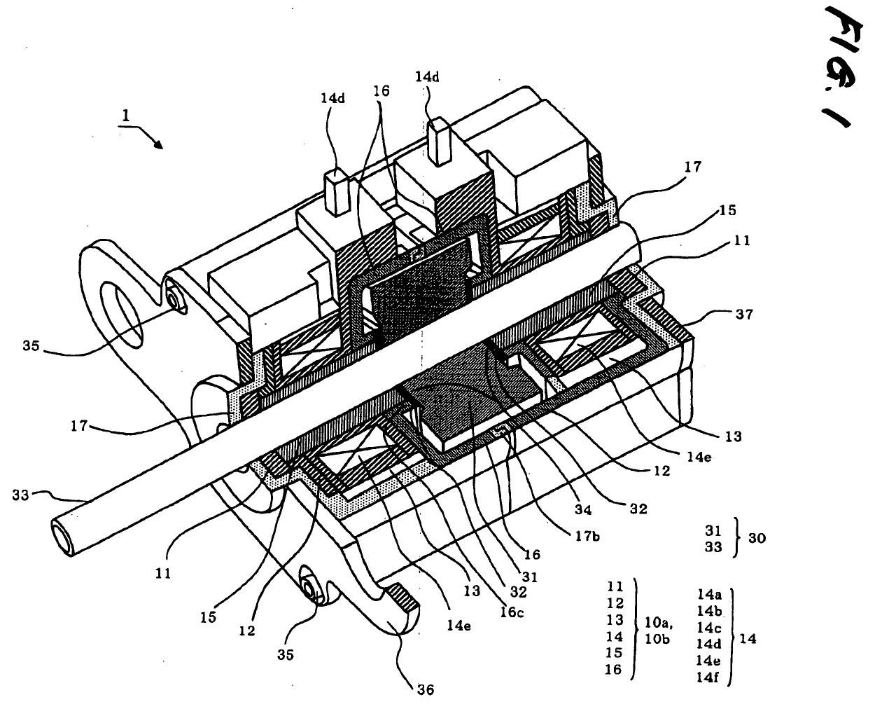

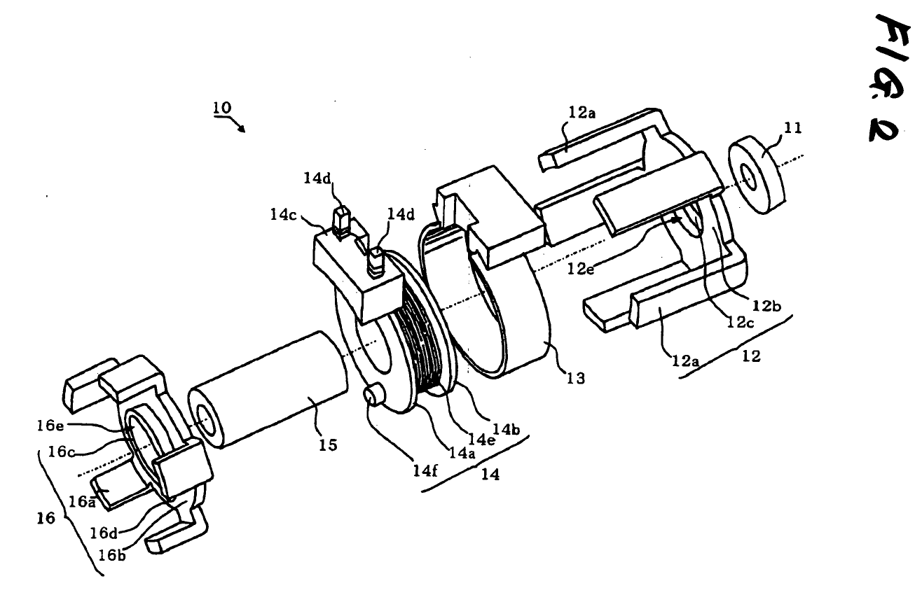

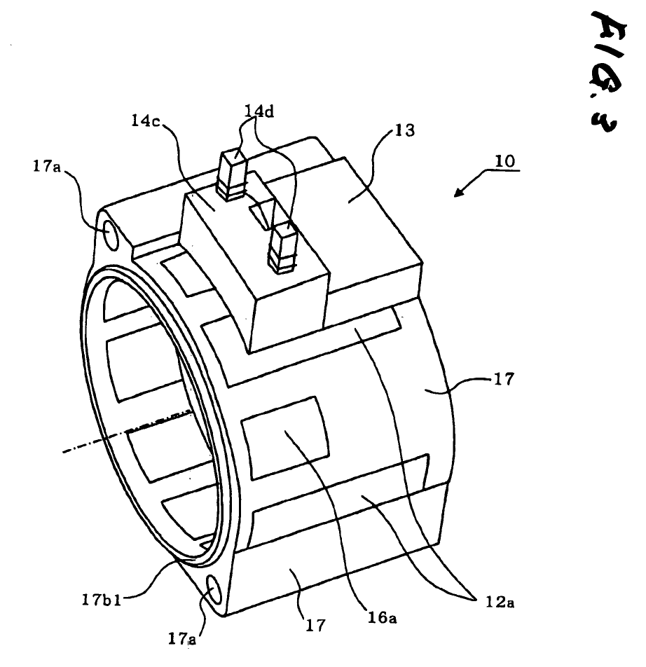

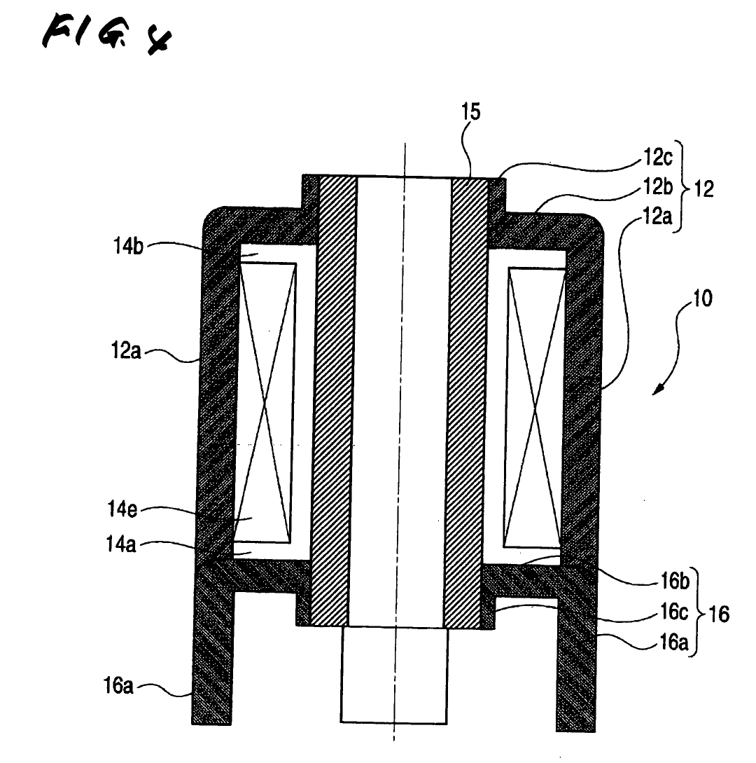

FIG. 1 is a partly sectional perspective view showing a structure of a stepping motor of the present invention. FIG. 2 is an exploded perspective view in a stator shown in FIG. 1. FIG. 3 is a perspective view showing a completed state of the stator by a resin mold. FIG. 4 is a schematic view showing a fitting state of an inner yoke, an outer yoke and a core. In a stepping motor 1, stators 10a and 10b having the same forms are arranged to be opposed at both end sides in the direction of a shaft (an axial direction) of a rotor magnet 31.

The stator 10 (10a, 10b) includes a bearing 11, an outer yoke 12, a covering 13, a bobbin 14, a core 15 and an inner yoke 16. The bearing 11 supports a shaft 33 of a rotor 30, and is formed with, for instance, an oil impregnated sintered bearing. It is to be understood that a ball bearing may be used.

The outer yoke 12 and the inner yoke 16 are formed with, for instance, a soft magnetic material such as an electro-galvanized steel plate, a silicon steel plate, an electromagnetic steel plate or the like. The outer yoke 12 and the inner yoke 16 have a plurality of pole teeth 12a and 16a, respectively.

The core 15 is formed with, for instance, a soft magnetic material such as pure iron, permalloy or the like and has a cylindrical hollow structure so that the shaft 33 can be inserted.

The bobbin 14 is formed with, for instance, a synthetic resin such as a liquid crystal polymer and a coil 14e having a winding wound is provided between flanges 14a and 14b. Further, in one flange 14a, a terminal base 14c having terminal pins 14d planted is integrally formed. A lead part of the coil 14e is wound on the terminal pins 14d and fixed thereto. Further, in the flange 14a, a protruding boss part 14f for positioning is formed. This boss part 14f is inserted into a hole 16d formed in a flat plate part 16b of the inner yoke 16 to position the bobbin 14. A substantially cylindrical covering 13 is mounted on the outer peripheral part of the coil 14. The covering 13 is formed with an insulating resin having flexibility.

The outer yoke 12 is formed by, for instance, punching the eletro-galvanized steel plate by a press to form a flat plate part 12b, pole teeth 12a and a tubular bending part 12c and then bending the parts of the pole teeth 12a in the opposite direction to the bending part 12c relative to the flat plate part 12b and in the direction at right angles to the flat plate part 12b. The bending part 12c is formed by pressing the central part of the flat plate part 12b so as to push out the central part when an opening part 12e is formed.

The inner yoke 16 is also formed by punching the eletro-galvanized steel plate by a press like the outer yoke 12 to form a flat plate part 16b, pole teeth 16a and a tubular bending part 16c and then bending the parts of the pole teeth 16a in the same direction as that of the bending part 16c and in the directions at right angles to the flat plate part 126. The bending part 16c is formed by pressing the central part of the flat plate part 16b so as to push out the central part when an opening part 16e is formed.

Then, the core 15 is fitted under pressure to the inner side of the tubular bending part 12c of the outer yoke 12 and the inner side of the tubular bending part 16c of the inner yoke 16 and fixed thereto.

At this time, as shown in FIG. 4, since each of the inner peripheral surface of the bending part 16c of the inner yoke 16 and the inner peripheral surface of the bending part 12c of the outer yoke 12 comes into contact with the outer peripheral surface of the core 15, contact areas between both are increased so that a magnetic resistance at these parts can be reduced. Therefore, a leakage flux can be reduced, and a magnetic flux can be efficiently transmitted to a magnetic circuit including the outer yokes 12, the inner yokes 16 and the rotor magnet 31.

Further, since the contact area in contact with the outer peripheral surface of the core 15 is increased more than that of an embodiment in the background art, the bonding strength of the outer yoke 12, the inner yoke 16 and the core 15 can be increased and more strongly connected together. Further, each of the bending part 12c of the outer yoke 12 and the bending part 16c of the inner yoke 16 is bent in the direction that is not opposed to the bobbin 14. Thus, the outer yoke, the inner yoke and the core can be connected together without reducing the number of turns (the number of windings) of the coil 14e.

Then, during molding, the bearing 11, the outer yoke 12, the covering 13, the bobbin 14, the core 15 and the inner yoke 16 for one set of one side stator 10a are set in a temporarily assembled state in a metal mold not shown in the drawing. At this time, the outer yoke 12 and the inner yoke 16 are positioned so as to have a phase difference of 180° in an electrical angle. After the components are set in the metal mold, a resin 17 is injected into the metal mold to integrally form the above-described components by the resin 17.

At this time, the portion between the pole teeth 12a of the outer yoke 12 and the portion between the pole teeth 16a of the inner yoke 16 are filled with the resin 17 and the bearing 11 is also fixed by the resin 17. Further, the resin 17 is formed so as to be longer than the end parts of the pole teeth 12a of the outer yoke 12 and the pole teeth 16a of the inner yoke 16 and an annular protruding part 17b1 (see FIG. 3) is formed. 17a designates holes into which pipes 35 for connecting the stators 10 are inserted, and the holes are formed at the same time when the resin 17 is injected into the metal mold. The covering 13 prevents the coil 14e from being broken due to the pressure and heat of the molding resin 17 to be injected.

The stator 10b of the other side is manufactured in the same way, and during injecting the resin 17 in the stator 10b of the other side, a protruding part 17b2 (an illustration is omitted) is also formed. The protruding part 17b2 of the other side is formed so as to be nested to the protruding part 17b1 of the stator 10a of the one side and these protruding parts 17b1 and 17b2 are nested and fitted to each other.

In the stepping motor 1, the stators 10a and 10b are arranged at both ends of the rotor magnet 31 so that a rotor 30 made of the rotor magnet 31 fixed to the shaft 33 is sandwiched in between the two stators 10a and 10b. At this time, both the stators 10a and 10b are arranged at positions having a phase difference of 90° in an electrical angle. A washer 32 is made of a sliding resin and mounted between the rotor magnet 31 and the core 15 at both sides of the rotor magnet 31 to form a prescribed space between the rotor magnet 31 and the core 15 and has a function for holding the rotor magnet 31 so as to freely slide.

An attaching plate 36 serves to attach the stepping motor 1 to an outer casing. The pipes 35 serve to connect the two stators 10a and 10b together. After the pipes 35 are inserted into the stators 10a and 10b, the attaching plate 36 disposed at one end side of the stator and an end plate 37 disposed at the other end side of the stator, the pipes 35 are crimped to connect the stators together. A magnetic interference between the stators 10a and 10b is prevented by the protruding part 17b (17b1, 17b2) of the resin 17, but a non-magnetic spacer may be mounted in place thereof. It is to be understood that the stators may be fixed together by screws or bolts in place of the pipes 35.

In this embodiment, since each of the bending part 12c of the outer yoke 12 and the bending part 16c of the inner yoke 16 is bent in the direction that is not opposed to the bobbin 14 so that the number of the turns (the number of windings) of the coil is not reduced, the axial length of the core 15 is longer by the length of the bending parts 12c and 16c. Accordingly, when both end faces of the rotor magnet 31 have plane structures, the outer peripheral area of the rotor magnet 31 is decreased so that the magnetic force of the rotor magnet 31 is reduced. Therefore, as shown in FIG. 1, recessed parts 34 are formed in areas near the shaft 33 of the rotor magnet 31 opposed to the bending parts 16c and the core 15 so that the outer peripheral area of the rotor magnet 31 is not decreased.

When there is a room in the structural, the bending part 12c of the outer yoke 12 and the bending part 16c of the inner yoke 16 may be arranged in the direction opposed to the bobbin 14. At that time, either the bending part 12c or the bending part 16c may be provided in the direction opposed to the bobbin 14.

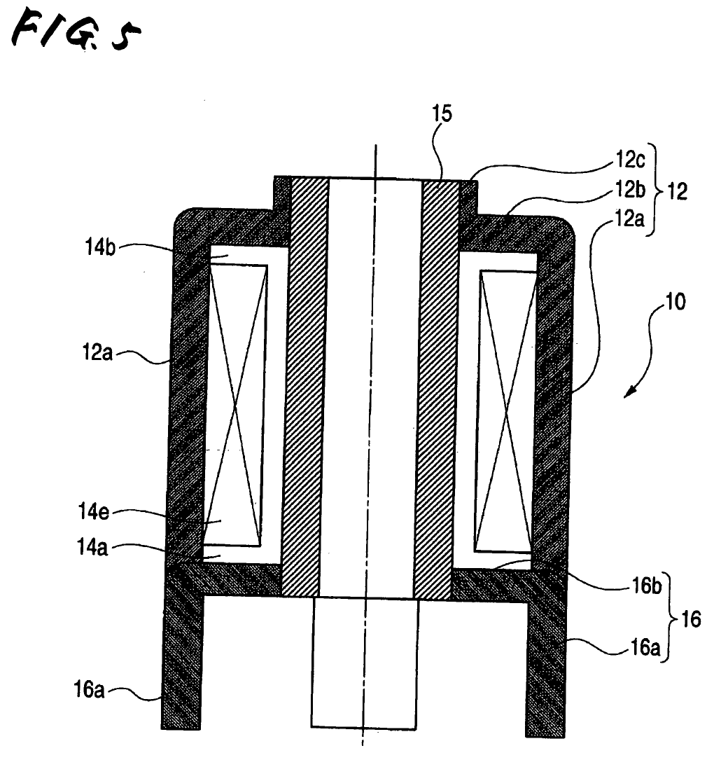

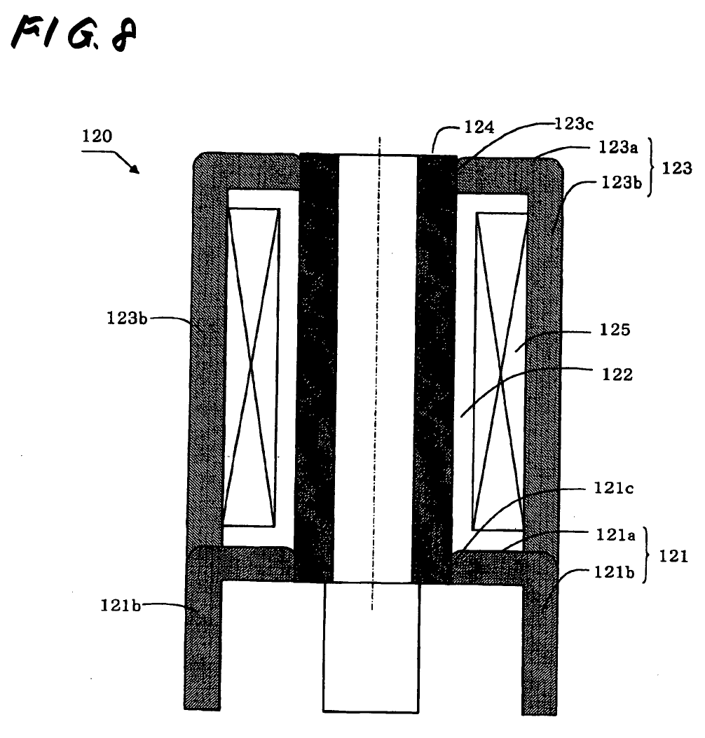

Further, in the case of a motor structure having an extremely small diameter, when the outside diameter of a rotor magnet 31 is small so that recessed parts 34 are hardly formed in faces opposed to the bending parts 16c of inner yokes 16, a bending part 12c may be formed only in an outer yoke 12 as shown in FIG. 5. In this case, the bending part 12c is formed only in the outer yoke 12, however, a magnetic efficiency is improved more than that of the structure in the background art as shown in FIG. 8.

The present invention is described in detail by referring to the specific embodiment. However, it is to be understood to a person ordinary skilled in the art that various changes or modifications may be made without departing the spirit and the scope of the present invention.

This application is based on Japanese Patent Application (JP application No. 2005-110409) filed on Apr. 6, 2005 and the contents thereof are incorporated herein by reference.

### INDUSTRIAL APPLICABILITY

A stepping motor of the present invention is advantageously used for an actuator of an optical disk device or a video camera.

1. A stepping motor comprising:
a rotor having a shaft and a rotor magnet; and
a pair of stators arranged to hold the rotor magnet from both end sides of the shaft,
wherein each of the pair of the stators includes an inner yoke and an outer yoke, each yoke having a plurality of pole teeth opposed to an outer peripheral surface of the rotor magnet, and a cylindrical core made of a magnetic material,
the inner yoke has a flat plate part having an opening part at a central thereof, the plurality of pole teeth of the inner yoke are continuously provided in an outer peripheral part of the flat plate part of the inner yoke and extend in an axial direction, and a tubular bending part is provided in the opening part in the same direction as that of the pole teeth of the inner yoke,
the outer yoke has a flat plate part having an opening part at a central part thereof, the plurality of pole teeth of the outer yoke are continuously provided in an outer peripheral part of the flat plate part of the outer yoke and extend in the axial direction, and a tubular bending part is provided in the opening part in a direction opposite to that of the pole teeth of the outer yoke,
the cylindrical core is fitted to the tubular bending part of each of the inner and outer yokes, and
the rotor magnet has a recessed part provided at a portion opposed to the tubular bending part of the inner yoke.

2-6. (canceled)
